(19) United States
(12) Patent Application Publication
(10) Pub. No.: US 2023/0330772 A1
(43) Pub. Date: Oct. 19, 2023

(54) LASER SHOCK PEENING APPARATUS

(71) Applicant: LSP Technologies, Inc., Dublin, OH (US)

(72) Inventors: Gary A. Walzer, Columbus, OH (US); Jeffrey A. Jewell, Ostrander, OH (US); Devin R. Hilty, Westerville, OH (US); Erich Zelmer, Newark, OH (US); Daniel Merrifield, Dublin, OH (US); Michael Snethen, Dublin, OH (US); Mark Bloomberg, Columbus, OH (US); Keith Glover, Dublin, OH (US); Avery Calhoun, New Albany, OH (US); Adam Hinerman, Lexington, OH (US); Roger S. Weikel, Fredericktown, OH (US); Tim Gorman, Columbus, OH (US)

(73) Assignee: LSP Technologies, Inc., Dublin, OH (US)

(21) Appl. No.: 18/156,474

(22) Filed: Jan. 19, 2023

Related U.S. Application Data
(63) Continuation of application No. PCT/US2021/042730, filed on Jul. 22, 2021.
(60) Provisional application No. 63/055,017, filed on Jul. 22, 2020.
(60) Provisional application No. 63/164,599, filed on Mar. 23, 2021.

(51) Int. Cl. B23K 26/06; B23K 26/067; B23K 26/08; B23K 26/146

(52) U.S. Cl. CPC B23K 26/0648; B23K 26/067; B23K 26/0884; B23K 26/146

(57) ABSTRACT

An apparatus for directing a laser beam to a workpiece surface includes a housing having a laser beam exit aperture. The apparatus further includes an output optical device configured to emit a converging laser beam. The converging laser beam is centered on an axis and is directed outward from the housing through the exit aperture toward a workpiece surface. A water nozzle outlet is arranged to discharge a stream of overlay water toward the workpiece surface. An air nozzle outlet is arranged to discharge a stream of air in a direction transverse to the axis at a location axially between the water nozzle and the exit aperture.

### CROSS-REFERENCE TO RELATED APPLICATIONS

This application claims priority from U.S. Provisional Patent Application No. 63/055,017, filed on Jul. 22, 2020, and from U.S. Provisional Patent Application No. 63/164,599, filed on Mar. 23, 2021, each of which is incorporated by reference herein in its entirety.

### BACKGROUND

In a laser shock peening process, a layer of overlay water is provided on the surface of a workpiece. A laser beam delivery device delivers a laser beam into the layer of overlay water to excite the water molecules and generate a shockwave at the surface. The shockwave hardens the workpiece by imparting residual stress to the workpiece. The configuration of the workpiece may require the delivery device to be moved throughout a range of rotational, pivotal, and other movements relative to the workpiece. This may cause inconsistencies in the orientation of the laser beam relative to the layer of overlay water at the surface of the workpiece.

### SUMMARY

An apparatus for directing a laser beam to a workpiece surface is provided. In one aspect, the apparatus includes a housing having a laser beam exit aperture. The apparatus may further include an output optical device configured to emit a converging laser beam. The converging laser beam is centered on an axis and is directed outward from the housing through the exit aperture toward the workpiece surface. A water nozzle outlet may be arranged to discharge a stream of overlay water toward the workpiece surface. An air nozzle outlet is arranged to discharge a stream of air in a direction across the axis at a location between the water nozzle and the exit aperture.

In an aspect presented as an example, a robotic device supports the housing for rotation about the axis of the laser beam. The robotic device also supports the housing for movement pivotally about an axis skewed to the axis of the laser beam. The water nozzle outlet and the air nozzle outlet are fixed to the housing such that the water nozzle outlet, the air nozzle outlet, and the housing are rotatable and pivotal together in orientations that are consistent relative to each other.

In another aspect presented as an example, an apparatus for directing a laser beam toward a workpiece surface includes a housing having an entry aperture configured to receive an optical fiber. An input optical device is arranged within the housing to receive a laser beam from an optical fiber in the entry aperture. The housing further has a laser beam exit aperture. An output optical device is arranged with the housing to direct the laser beam outward through the exit aperture toward a workpiece surface. A laser light energy detector is arranged within the housing to detect laser light energy between the input optical device and the output optical device.

### BRIEF DESCRIPTION OF THE FIGURES

FIG. 1 is a view of a robot and a laser beam delivery device mounted on the robot.

FIG. 2 is an enlarged view of the laser beam delivery device and a portion of the robot of FIG. 1.

FIG. 3 is a view similar to FIG. 2, showing parts in different positions.

FIG. 4 is a view similar to FIG. 1, showing parts in different positions.

FIG. 5 is a view similar to FIGS. 2 and 3, also showing parts in different positions.

FIG. 6 is an enlarged view of the laser beam delivery device of FIG. 1.

FIG. 7 is a sectional view of the laser beam delivery device of FIG. 4.

FIG. 8 is also a sectional view of the laser beam delivery device of FIG. 4.

FIG. 9 is a schematic view of optics in an alternative aspect of a laser beam delivery device.

FIG. 10 is a side sectional view of an alternative aspect of a laser beam delivery device.

FIG. 11 is an end view of the device of FIG. 10.

FIG. 12 is a sectional view taken on line C-C of FIG. 10.

### DETAILED DESCRIPTION

The structures illustrated in the drawings include parts that are examples of the elements recited in the claims. The illustrated structures thus include examples of how a person of ordinary skill in the art can make and use the apparatus defined by the claims. They are described here to provide enablement and best mode under the patent statute without imposing limitations that are not recited in the claims. One or more of the elements of one aspect may be used in combination with, or as a substitute for, one or more elements of another as needed for any aspect of the claimed apparatus.

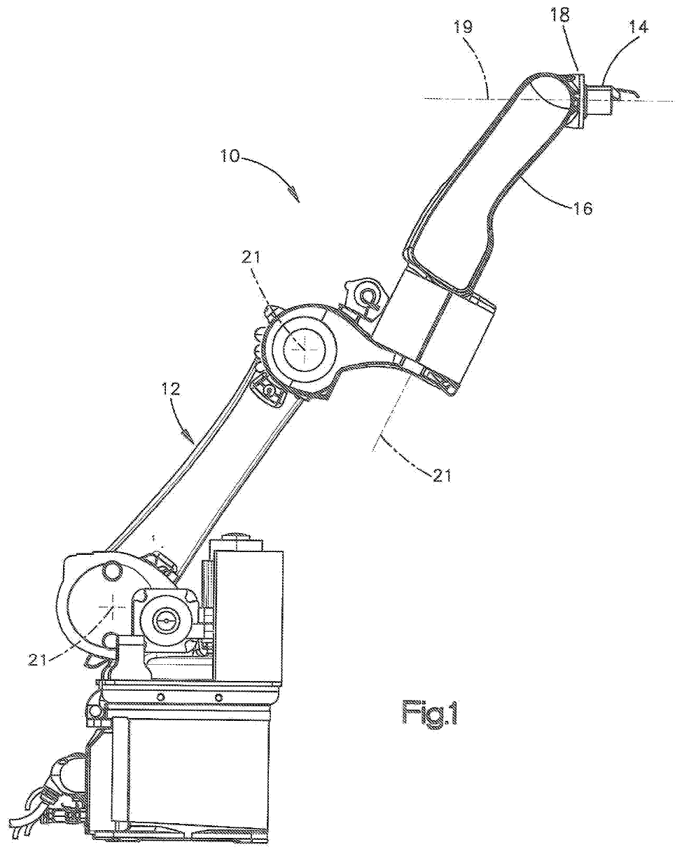

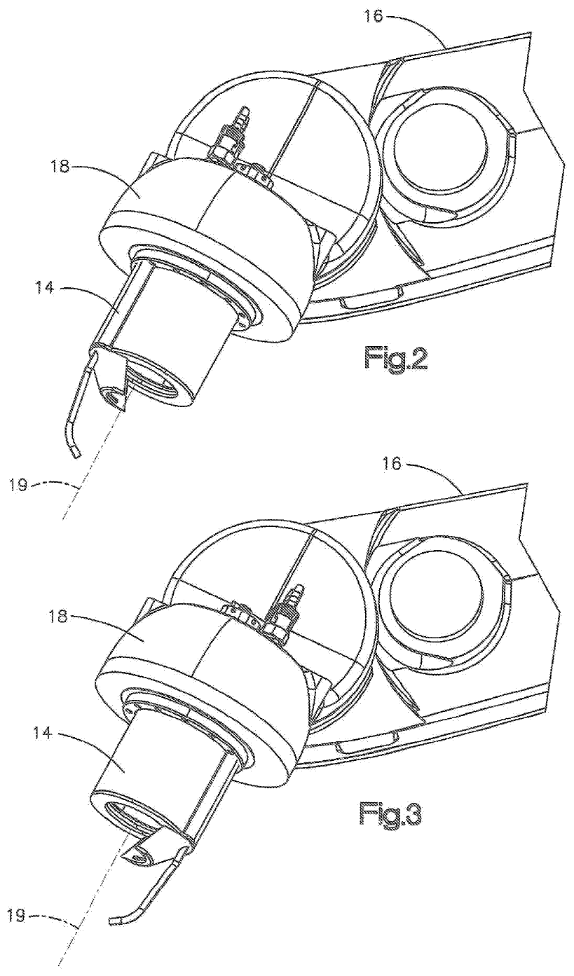

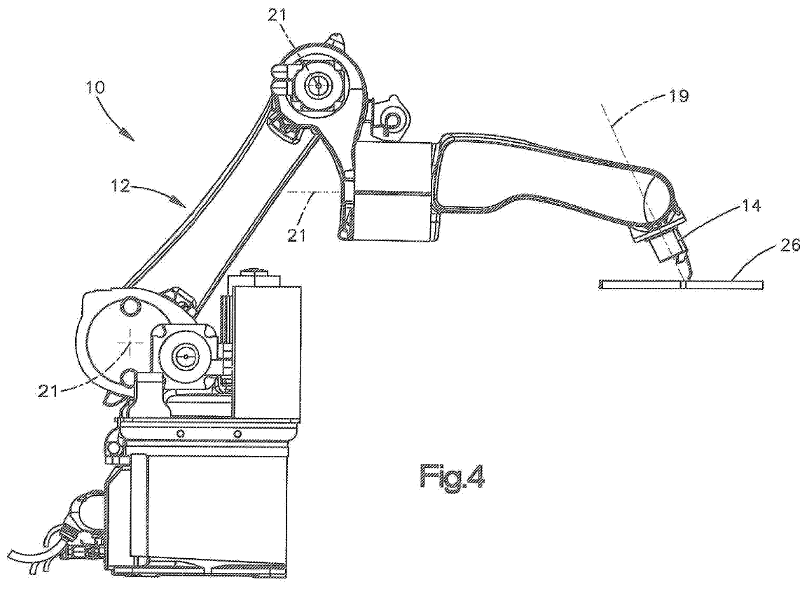

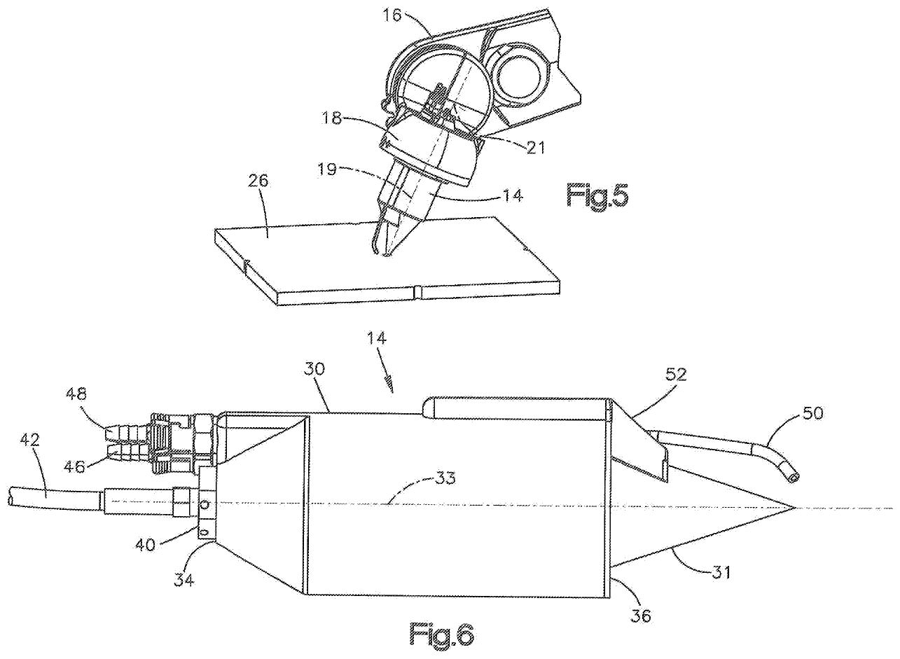

The apparatus 10 shown in FIG. 1 includes a robot 12 and a laser beam delivery device 14. The delivery device 14 is mounted on an articulated arm 16 of the robot 12. In the given example, the delivery device 14 is mounted coaxially within a hub 18 at the distal end of the arm 16. The robot 12 is operative to rotate the hub 18 about the axis 19 of the hub 18, as shown in FIGS. 2 and 3. The robot 12 also operates to move the arm 16 pivotally about various axes 21 that are transverse or otherwise skewed relative to the axis 19 of the hub 18, as shown in FIGS. 1, 4, and 5. In this manner, the robot 12 carries the delivery device 14 between various positions and orientations relative to a workpiece 26 (FIGS. 4 and 5) as needed to perform laser shock peening processes at multiple locations on the surface of the workpiece 26.

As shown in FIG. 6, the delivery device 14 includes a housing 30 containing optics for emitting a laser beam 31. The housing 30 in the given example is elongated with a longitudinal axis 33, a proximal end 34, and a distal end 36. A fitting 40 at the proximal end 34 attaches an optical fiber 42 to the housing 30 in a position centered on the axis 33. The fitting 40 in this example is configured for the housing 30 and the optical fiber 42 to rotate about the axis 33 relative to one another upon rotation of the housing 30 coaxially with the hub 18 on the robot arm 16.

Additional fittings are provided at the proximal end 34 of the housing 30 in positions spaced radially from the axis 33. These include a water line fitting 46 and an air line fitting 48. A water nozzle 50 projects from the distal end 36 of the housing 30. An air nozzle 52 also projects from the distal end 36 of the housing 30.

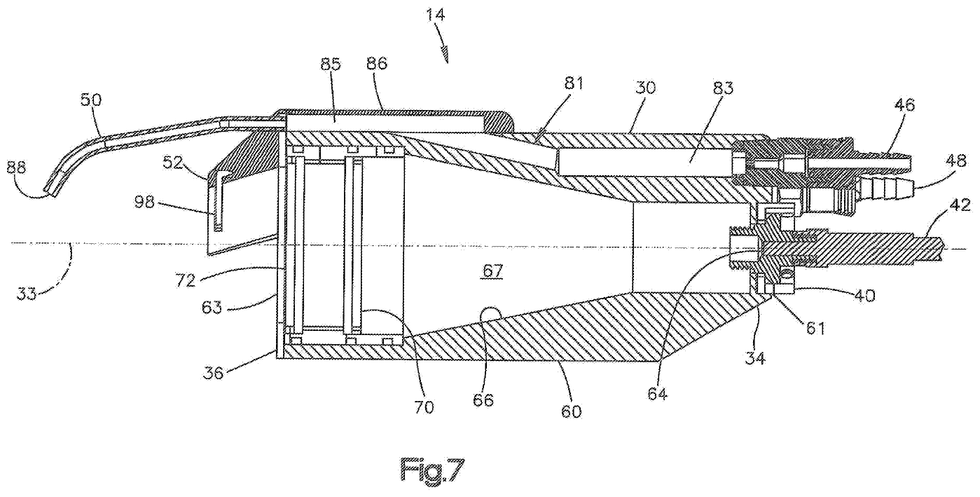

As shown in greater detail in FIG. 7, the housing 30 has a generally cylindrical tubular body wall 60 with an entry aperture 61 at the proximal end 34 and an exit aperture 63 at the distal end 36. The fitting 40 supports the optical fiber 42 in the entry aperture 61, with the end 64 of the optical fiber 40 centered on the axis 33. An inner surface 66 of the body wall 60 surrounds an optical passage 67 that is centered on the axis 33. The optical passage 67 reaches axially from the entry aperture 61 to the exit aperture 63 and contains a pair of optical devices 70 and 72 that are centered on the axis 33.

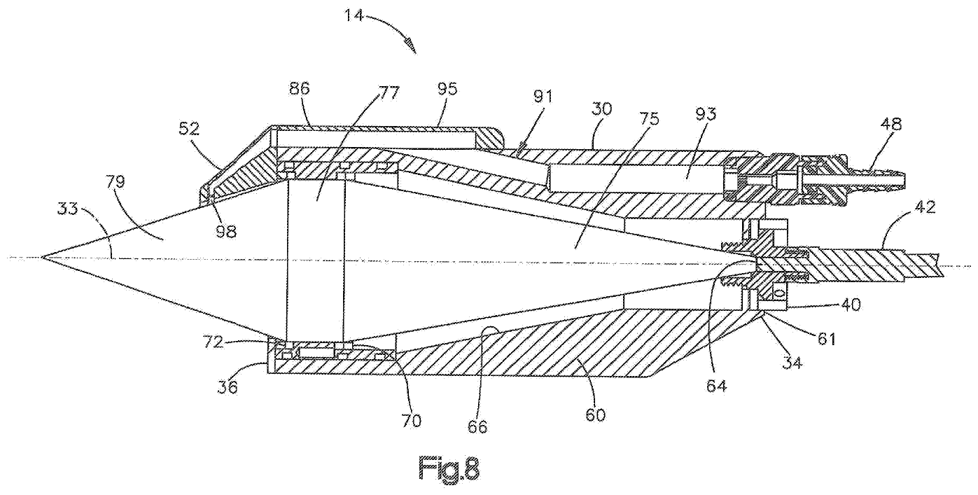

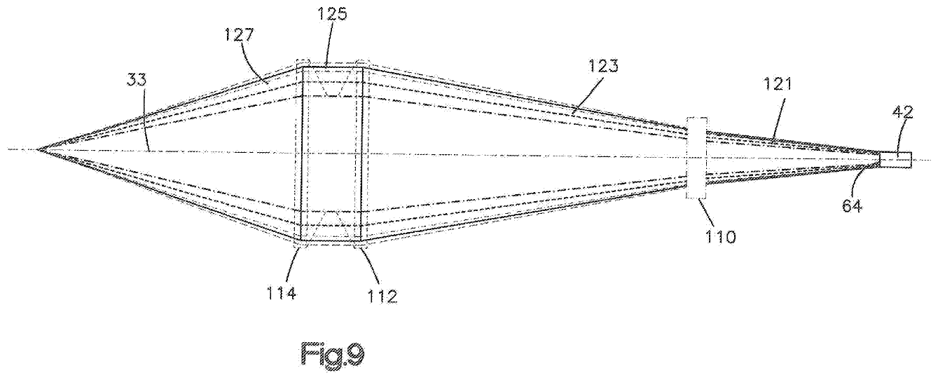

The first optical device 70 in this example is a lens that is arranged to receive a diverging laser beam 75 from the end 64 of the optical fiber 42, as shown in FIG. 8, and is configured to emit a collimated laser beam 77. The second optical device 72 in this example also is a lens and is arranged to receive the collimated laser beam 77 from the first optical device 70. The second optical device 72 is configured to output a converging laser beam 79 that is centered on the axis 33 and directed outward from the housing 30 through the exit aperture 63.

Referring again to FIG. 7, a water passage 81 reaches within the housing 30 from the water line fitting 46 to the distal end 36. A first section 83 of the water passage 81 is defined within the thickness of the body wall 60. A second section 85 is defined within a radially enlarged portion 86 of the housing 30. The water nozzle 50 projects distally from that portion 86 of the housing 30. An outlet 88 at the end of the water nozzle 50 is spaced radially from the axis 33 and is oriented to discharge a stream of overlay water in a direction skewed to the axis 33. More specifically, the stream of overlay water is preferably directed toward the focal point of the converging laser beam 79 and thereby to provide a layer of overlay water for laser shock peening of the workpiece 26 at that location.

As further shown in FIG. 8, an air passage 91 reaches within the housing 30 from the air line fitting 48 to the distal end 36. A first section 93 of the air passage 91 is defined within the thickness of the body wall 60. A second section 95 is defined within the radially enlarged portion 86 of the housing 30. The air nozzle 52 projects distally from that portion 86 of the housing 30. An outlet 98 of the air nozzle 52 is spaced radially from the axis 33 and is located axially between the water nozzle outlet 88 (FIG. 7) and the distal end 36 of the housing 30. The air nozzle outlet 98 is thus arranged to discharge a stream of air across the axis 33 at a location axially between the exit aperture 63 and the stream of overly water.

In this example, the air nozzle outlet 98 is configured as a slot with an arcuate configuration reaching circumferentially about the axis 33, as shown partially in FIG. 7. This directs the air stream to flow radially across second optical device 72 in a direction perpendicular to the axis 33. The air stream shields the second optical device 72 from particles ejected from the workpiece 26 under the influence of the laser shock peening process, thereby protecting the second optical device 72 from damage that might otherwise be caused by the impact of such particles.

Further regarding the water nozzle 50 and the air nozzle 52, those parts of the delivery device 14 are fixed to the housing 30. Accordingly, the water nozzle outlet 88, the air nozzle outlet 98, and the housing 30 all move together in orientations that remain consistent relative to each other upon rotation of the housing 30 with the hub 18 on the robot arm 16. This provides consistency in the layer of overlay water and in the stream of air for protection of the second optical device 72, throughout the entire range of positions and orientations through which the delivery device 14 is moved relative to the workpiece 26 in the laser shock peening process.

In an alternative aspect, a laser beam delivery device may include optical devices as shown schematically in FIG. 9. This aspect includes first, second, and third optical devices 110, 112, and 114. The first optical device 110 is arranged within the housing 30 (FIG. 8) to receive a diverging laser beam 121 from the optical fiber 42, and is configured to emit a further diverging laser beam 123. The second optical device 112 is arranged within the housing 30 to receive the further diverging laser beam 123 from the first optical device 110 and is configured to emit a collimated laser beam 125. The third optical device 114 is arranged to receive the collimated laser beam 125 from the second optical device 112 and is configured to emit a converging laser beam 127. The converging laser beam 127 is centered on the axis 33 and is directed outward from the housing 30 through the exit aperture 63 (FIG. 7) toward the workpiece surface. In this arrangement, the first optical device 110 and the further diverging laser beam 123 enable the length of the optical path through the housing 30, as well as the length of the housing 30 itself, to be less than described above.

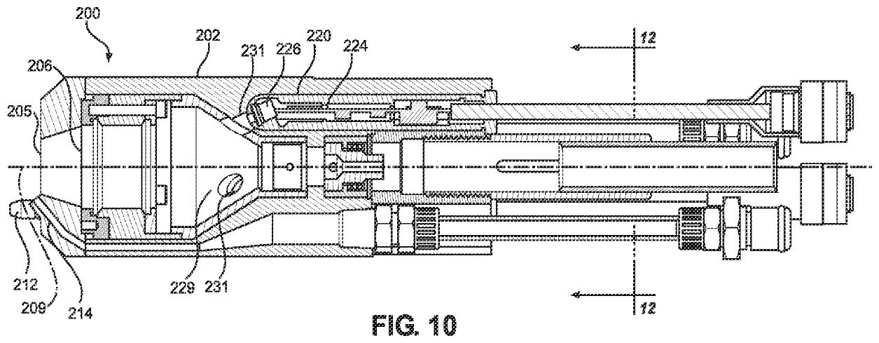

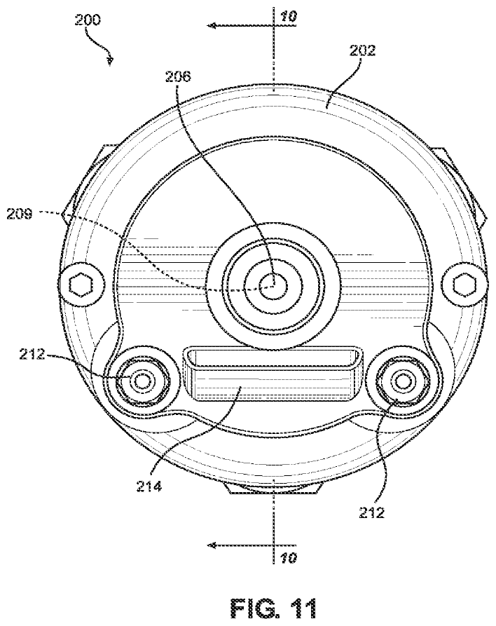

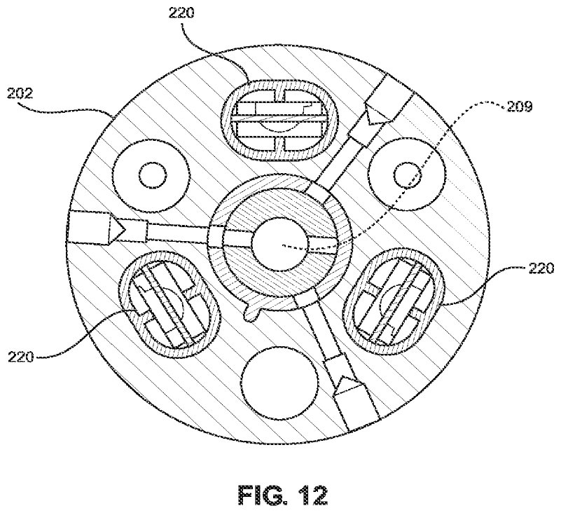

FIGS. 10-12 show another alternative aspect of a laser beam delivery device 200 for emitting a laser beam toward a workpiece for laser shock peening. Like the delivery device 14 described above, the delivery device 200 includes a housing 202 with a laser beam exit aperture 205. An output optical device 206 is configured to direct a converging laser beam outward from the exit aperture 205 along an axis 209. A pair of water nozzle outlets 212 (FIG. 11) are arranged on the housing 202 to direct streams of overly water toward the workpiece surface. An air nozzle 214 is arranged on the housing 202 to discharge a stream of air in a direction across the axis 209 at a location axially between the exit aperture 205 and the stream of overly water. The air stream shields the output optical device 206 from particles ejected from the workpiece under the influence of the laser shock peening process.

Additional components of the device 200 include laser light energy detectors. In this example, shown in FIG. 12, each laser light energy detector includes a photodiode 220. Each photodiode 220 is arranged within the housing 202 to detect laser light energy between the input optical device 224 and the output optical device 206. Any one or more of the photodiodes 220 can thereby detect laser light energy below a threshold level that is predetermined to indicate a break or other failure in the optical fiber conveying the laser light energy to the device 200.

The laser light energy detectors in the device 200 further include attenuators 226, one of which is shown in FIG. 10. Each attenuator 226 is operatively associated with a respective one of the photodiodes 220 to reduce the amount of laser light incident at the respective photodiode 220.

As shown in FIG. 12, the device 200 in this example includes three photodiodes 220 that are equally spaced apart circumferentially in a circular array centered on the axis 209. Each photodiode 220 is coupled with a corresponding attenuator 226, as shown in FIG. 10. Specifically, the housing 200 has a primary optical passage 229 centered on the axis 209 between the input optical device 224 and the output optical device 206. Three secondary optical passages 231, two of which are shown in FIG. 10, reach radially outward from the primary passage 229. Each secondary passage 231 communicates the primary passage 229 with a corresponding one of the attenuators 226 at the photodiodes 220. This enables each photodiode 220 to detect laser light energy between the input optical device 224 and the output optical device 206 as described above.

A system including the delivery device 200 may also include detection circuitry configured to monitor energy detected by the photodiodes 220 or other laser light energy detectors. Such circuitry may be further configured to compare the detected energy with a threshold level that is predetermined to indicate a break or other failure in the optical fiber connected with the device 200. Accordingly, the circuitry could also be configured to respond to detection of energy below the threshold level by terminating the transmission of laser light energy into optical fiber. An example fiber break detection system is described in U.S. Provisional Patent Application No. 63/164,599.

This written description sets forth the best mode of carrying out the invention and describes the invention to enable a person of ordinary skill in the art to make and use the invention, by presenting examples of the elements recited in the claims. The detailed descriptions of those examples do not impose limitations that are not recited in the claims. what is claimed is:

1. An apparatus for directing a laser beam to a workpiece surface, the apparatus comprising:
a housing having a laser beam exit aperture;
an output optical device configured to emit a converging laser beam, wherein the converging laser beam is centered on an axis and directed outward from the housing through the exit aperture toward a workpiece surface;
a water nozzle outlet arranged to discharge a stream of overlay water toward the workpiece surface; and
an air nozzle outlet arranged to discharge a stream of air in a direction across the axis at a location axially between the exit aperture and the stream of overlay water.

2. An apparatus as defined in claim 1, wherein the water nozzle outlet and the air nozzle outlet are fixed to the housing such that the water nozzle outlet, the air nozzle outlet, and the housing are movable together in orientations that are consistent relative to each other.

3. An apparatus as defined in claim 2, wherein the axis is a first axis, and further comprising a robotic device, wherein the robotic device supports the housing for rotation about the first axis and for movement pivotally about a second axis skewed to the first axis.

4. An apparatus as defined in claim 1, wherein the air nozzle outlet is spaced from the output optical device along the axis.

5. An apparatus as defined in claim 1, wherein the air nozzle outlet is configured as a slot with an arcuate configuration reaching circumferentially about the axis.

6. An apparatus as defined in claim 1, wherein the housing has an entry aperture configured to receive an optical fiber, and further comprising a first optical device, wherein the first optical device is arranged within the housing to receive a diverging laser beam from an optical fiber in the entry aperture and is configured to emit a further diverging laser beam.

7. An apparatus as defined in claim 6, further comprising a second optical device, wherein the second optical device is arranged within the housing to receive the further diverging laser beam from the first optical device and is configured to emit a collimated laser beam.

8. An apparatus as defined in claim 7, wherein the output optical device is a third optical device arranged to receive the collimated laser beam from the second optical device.

9. An apparatus as defined in claim 1, wherein the housing comprises an elongated tubular body having a longitudinal axis, and the output optical device is configured to center the converging laser beam on the longitudinal axis of the housing.

10. An apparatus as defined in claim 9, wherein the first, second, and third optical devices are lenses centered on the longitudinal axis of the housing.

11. An apparatus for directing a laser beam to a workpiece surface, the apparatus comprising: a housing having a laser beam exit aperture; an output optical device configured to emit a converging laser beam through the exit aperture toward the workpiece surface; a water nozzle outlet arranged to discharge a stream of overlay water toward the workpiece surface; an air nozzle outlet arranged to discharge a stream of air across the converging laser beam; and a robotic device supporting the housing for rotation about a first axis and for movement pivotally about a second axis skewed to the first axis.

12. An apparatus as defined in claim 11, wherein the water nozzle outlet and the air nozzle outlet are fixed to the housing such that the water nozzle outlet, the air nozzle outlet, and the housing are movable together in orientations that are consistent relative to each other.

13. An apparatus as defined in claim 12, wherein the converging laser beam is centered on the first axis, the water nozzle outlet is arranged to discharge the stream of overlay water toward the workpiece surface in a direction skewed to the first axis, and the air nozzle outlet is arranged to discharge the stream of air in a direction across the first axis at a location axially between the exit aperture and the stream of overlay water.

14. An apparatus as defined in claim 13, wherein the air nozzle outlet is spaced from the output optical device along the first axis.

15. An apparatus as defined in claim 13, wherein the air nozzle outlet is configured as a slot with an arcuate configuration reaching circumferentially about the first axis.

16. An apparatus as defined in claim 11, wherein the housing has an entry aperture configured to receive an optical fiber, and further comprising a first optical device, wherein the first optical device is arranged within the housing to receive a diverging laser beam from an optical fiber in the entry aperture and is configured to emit a further diverging laser beam.

17. An apparatus as defined in claim 16, further comprising a second optical device, wherein the second optical device is arranged within the housing to receive the further diverging laser beam from the first optical device and is configured to emit a collimated laser beam.

18. An apparatus as defined in claim 17, wherein the output optical device is a third optical device arranged to receive the collimated laser beam from the second optical device.

19. An apparatus as defined in claim 11, wherein the housing comprises an elongated tubular body having a longitudinal axis, and the output optical device is configured to center the converging laser beam on the longitudinal axis of the housing.

20. An apparatus as defined in claim 19, wherein the first, second, and third optical devices are lenses centered on the longitudinal axis of the housing.

21. -40. (Canceled)
